(19) United States
(12) Patent Application Publication
(10) Pub. No.: US 2008/0019411 A1
(43) Pub. Date: Jan. 24, 2008

(54) Compact sealed-off excimer laser

(76) Inventors: Norbert Niemoeller, Ebergoetzen (DE); Igor Bragin, Goettingen (DE); Rainer Paetzel, Dransfeld (DE); Rustem Osmanow, Rosdorf (DE); Juergen Witt, Schesslitz (DE)

Correspondence Address: STALLMAN & POLLOCK LLP, 353 SACRAMENTO STREET, SUITE 2200, SAN FRANCISCO, CA, 94111, US

(21) Appl. No.: 11/490,386

(22) Filed: Jul. 20, 2006

(51) Int. Cl. H01S 3/22

(52) U.S. Cl. 372/55

(57) ABSTRACT

An excimer laser is disclosed in which a gas-discharge is formed for exciting an excimer-forming lasing-gas mixture. The gas discharge is formed between an elongated anode electrode and a elongated cathode electrode. The anode is in contact with a dielectric surface and the cathode is supported above the dielectric surface, laterally spaced from and parallel to the anode. The gas-discharge has a surface-discharge or sliding discharge portion extending from the anode over the dielectric surface, and a volume-discharge portion connecting the sliding-discharge portion to the cathode. The volume-discharge excites the lasing-gas mixture. A laser resonator is arranged to generate laser radiation from the excited gas mixture. The sliding-discharge has homogeneous, stable characteristics that are inherited by the volume-discharge. An ion-wind generator provides circulation of the lasing-gas mixture through the volume-discharge.

### TECHNICAL FIELD OF THE INVENTION

The present invention relates in general to lasers delivering ultraviolet (UV) radiation. The invention relates in particular to excimer lasers delivering UV radiation at wavelengths of 353 nm or less.

### DISCUSSION OF BACKGROUND ART

Excimer lasers are presently the only commercially available lasers capable of generating fundamental radiation having a wavelength less than 353 nm. The term “excimer”, as used in this description, refers to a short-lived molecule that bonds two molecules when in an electronic excited state. The molecules, here, are gaseous molecules. In an excimer laser, the molecules are excited by impact with energetic, inert gas molecules that have been energized by creating a pulsed gas-discharge in the inert gas. The lifetime of the excimer is usually on the order of several nanoseconds, after which the components of the molecular excimer strongly disassociate and repel, returning the components to the ground state, and giving up excited-state energy as UV radiation. In an excimer laser, the gas discharge is formed in a volume between two reflective elements forming a resonator. The UV radiation is amplified by stimulated emission in the resonator, and a fraction of the amplified radiation circulating in the resonator is coupled out of the resonator as output radiation.

An excimer can be created by an excited-state interaction between two molecules of the same element, or by an interaction between two molecules each of a different element. One group of elements that can provide excimer interaction when energized consists of helium, neon, argon, krypton, and xenon. A gas including only any one of these elements can produce an excimer. Such excimers can be referred to as same-element excimers and can be correspondingly designated He₂* (60), Ne₂* (80), Ar₂* (128), Kr₂* (145), and Xe₂* (172). Numbers in parentheses indicate the peak-emission wavelength in nanometers. Another group of elements (halogens) that can provide same-element excimers consists of fluorine, chlorine, bromine, and iodine. These elements provide excimers F₂* (157), Cl₂* (258), Br₂* (290), and I₂* (343), respectively. F₂* (molecular fluorine) excimer lasers are used extensively in optical lithography operations in the semiconductor industry.

A two-element excimer can be created between an element from the first group and an element from the halogen group. Such two-element excimers are also referred to as exciplexes and include NeF* (108), ArF* (193), KrF* (248), XeF* (351), ArCl* (175), KrCl* (222), XeCl* (308), KrBr* (206), XeBr* (282), KrI* (185) and XeI* (253). F2*, ArF*, KrF*, XeF and XeCl are the excimers (exciplexes) of the most common, commercially available excimer lasers

Development efforts for these commercial excimer lasers have been driven originally by above-mentioned optical lithography applications and, more recently, by material processing applications such as selective laser crystallization of silicon. For these applications, development efforts have concentrated on providing high power consistent with high beam quality and wavelength stability. Commercially available lasers for these applications can provide up to 1000 Watts (W) of average power, in pulses of between about 10 nanoseconds (ns) and 200 ns duration at a pulse repetition frequency (PRF) of up to about 6 kilohertz (kHz). These high-power excimer lasers typically include gas-circulation fans for forcing the excimer-forming gas mixture to flow between gas discharge electrodes. Circulating gas must be passed over refrigeration traps. High-energy electrical pulses are required to provide the gas discharge pulses. Principle challenges in the design and development of such lasers include maintaining gas-discharge stability at a high discharge-power.

There are applications for a UV laser beam that require a beam with only a relatively low energy and average power, for example, no more than a few Watts but with high beam quality and pointing stability. A compact reliable and relatively inexpensive excimer laser, free of moving parts could potentially provide adequate performance for these applications.

### SUMMARY OF THE INVENTION

The present invention is directed to providing a compact excimer laser. In one aspect a laser in accordance with the present invention comprises an enclosure containing a lasing-gas. A dielectric member is located in the enclosure. An arrangement of electrodes includes a first elongated electrode in contact with and extending along a surface of the dielectric member and a second elongated electrode supported above that surface of the dielectric member, laterally spaced from the first electrode, and parallel thereto. The first and second electrodes are configured such that when a potential difference is established therebetween, the electrodes are electrically connected by a gas-discharge in the lasing gas. The gas-discharge has a surface-discharge portion extending from the first electrode, over said dielectric surface, and a volume-discharge portion connecting the surface-discharge portion to the second electrode. A laser resonator has a longitudinal axis extending through said volume discharge portion of said gas-discharge. An ion-wind generator provides circulating of the lasing-gas mixture through the volume discharge.

In a preferred embodiment of the inventive laser, the dielectric member is a sapphire cylinder. The sapphire cylinder is eccentrically located in an alumina cylinder, leaving a gap between the cylinders. The gap has a narrowest portion and a diametrically opposite widest portion. The first electrode is in contact with the outer surface of the sapphire cylinder over a portion of the circumference thereof remote from the narrowest portion of the gap. The second electrode is in contact with the inner surface of the alumina cylinder with one edge thereof aligned with the narrowest portion of the gap. The electrode arrangement further includes a third electrode electrically connected to the second electrode and in contact with the inner surface of the sapphire cylinder over about one half of the circumference of the cylinder with one edge of this third electrode being aligned with the narrowest portion of the gap. One edge of the first electrode is aligned with the other edge of the third electrode and the other edge of the first electrode is aligned about midway between the edges of the third electrode. The surface-discharge portion of the gas-discharge covers the outer surface of the sapphire cylinder from this other edge of the second electrode to the narrowest portion of the gap. The volume-discharge portion of the gas discharge occurs in the narrowest portion of the gap and electrically connects the surface discharge portion of the gas discharge to the second electrode. The ion-wind generating arrangement includes a wire-mesh electrode extending across and along the gap near the widest portion thereof and a single-wire electrode spaced apart from the wire-mesh electrode and located about midway across the gap. A high potential is applied to the single-wire electrode creating a corona discharge therearound. Ions created in the discharge are repelled by the wire electrode, and accelerated by and through the mesh electrode to create the ion-wind.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a lateral cross-section view schematically illustrating one preferred embodiment of a sealed-off excimer laser in accordance with the present invention including a metal cylindrical enclosure, two dielectric cylinders arranged one within the other within the enclosure, a first cathode on the inside of one of the cylinders and a second cathode on the inside of the other cylinder, an anode on the outside of that other cylinder, and an ion-wind generating arrangement including a wire electrode and a grid electrode.

FIG. 1A schematically illustrates important dimensions of the laser of FIG. 1.

FIG. 2 is a longitudinal cross-section view schematically illustrating one preferred assembly arrangement for the laser of FIG. 1.

FIG. 3A is a cross-section view schematically illustrating an arrangement of anode and cathode electrodes on a dielectric barrier for creating a sliding gas discharge according to prior-art principles.

FIG. 3B is a three-dimensional view schematically illustrating detail of the cathode electrode and dielectric barrier of the electrode arrangement of FIG. 3A.

FIG. 4A is a cross-section view schematically illustrating one experimental arrangement of a laser in accordance with the present invention including a first strip-electrode on a dielectric surface and a second strip-electrode supported above the dielectric surface and laterally spaced from the first electrode for creating a gas discharge including a surface-discharge portion and a volume-discharge portion in accordance with principles of the present invention.

FIG. 4B is a foreshortened plan view from above schematically illustrating further detail of the experimental laser of FIG. 4A including a laser resonator having a longitudinal axis extending through a location between the electrodes where the volume-discharge portion of the gas-discharge occurs.

FIG. 5A is a cross-section view schematically illustrating another experimental arrangement of a laser in accordance with the present invention similar to the laser of FIG. 4A, but wherein the second strip electrode is replaced by rod electrode supported above the dielectric surface and laterally spaced from the first electrode.

FIG. 5B is a foreshortened plan view from above schematically illustrating further detail of the experimental laser of FIG. 5A including a laser resonator having a longitudinal axis extending through a location between the second electrode and the dielectric surface where the volume-discharge portion of the gas-discharge occurs.

FIG. 6 is a lateral cross-section view schematically illustrating another preferred embodiment of a sealed-off excimer laser in accordance with the present invention, similar to the laser of FIG. 1 but wherein there is only one dielectric cylinder within the enclosure, the first cathodes is attached to a dielectric plate located within the enclosure and the ion-wind generating arrangement does not include a grid electrode.

FIG. 7 is a lateral cross-section view schematically illustrating yet another preferred embodiment of a sealed-off excimer laser in accordance with the present invention, similar to the laser of FIG. 6 but wherein the first cathode has a shape different from the first cathode of the laser of FIG. 6 and the ion-wind generating arrangement includes a grid electrode.

FIG. 8 is a lateral cross-section view schematically illustrating still another preferred embodiment of a sealed-off excimer laser in accordance with the present invention, similar to the laser of FIG. 7 but wherein the ion-wind generating arrangement does not include a grid electrode.

FIG. 9 is a lateral cross-section view schematically illustrating a further preferred embodiment of a sealed-off excimer laser in accordance with the present invention, similar to the laser of FIG. 8 but wherein the dielectric plate is omitted and the first cathode is suspended from a high voltage electrical feedthrough in the metal cylindrical enclosure.

FIG. 10 is a lateral cross-section view schematically illustrating still yet another preferred embodiment of a sealed-off excimer laser in accordance with the present invention, including a metal rectangular enclosure, a dielectric plate, a first cathode suspended above an upper surface of the dielectric plate, a second cathode in contact with a lower surface of the dielectric plate, and an anode in contact with the upper surface of the dielectric plate, and an ion-wind generating arrangement including a wire electrode but not including a grid electrode.

### DETAILED DESCRIPTION OF THE INVENTION

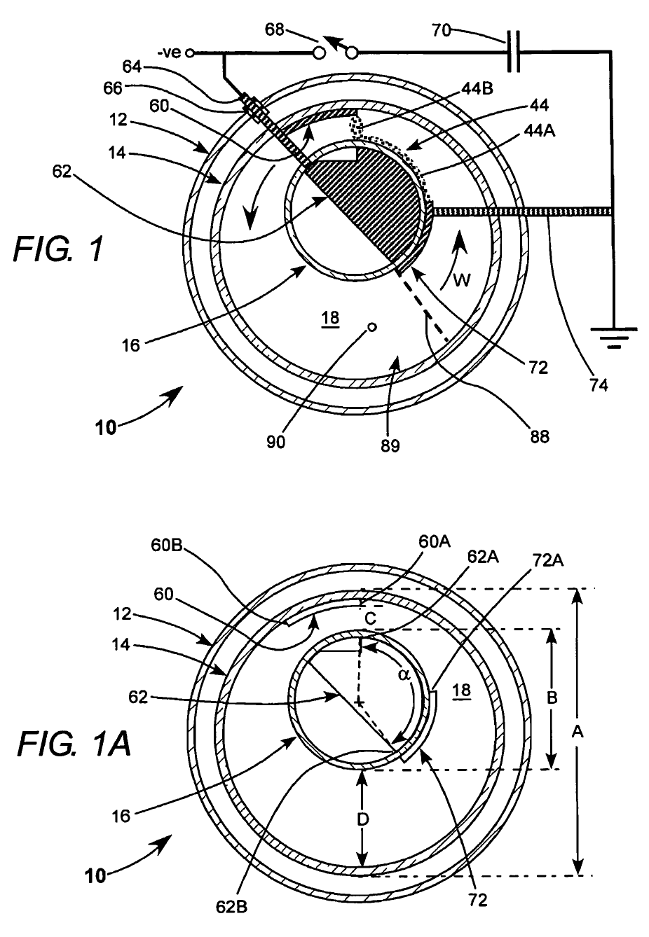

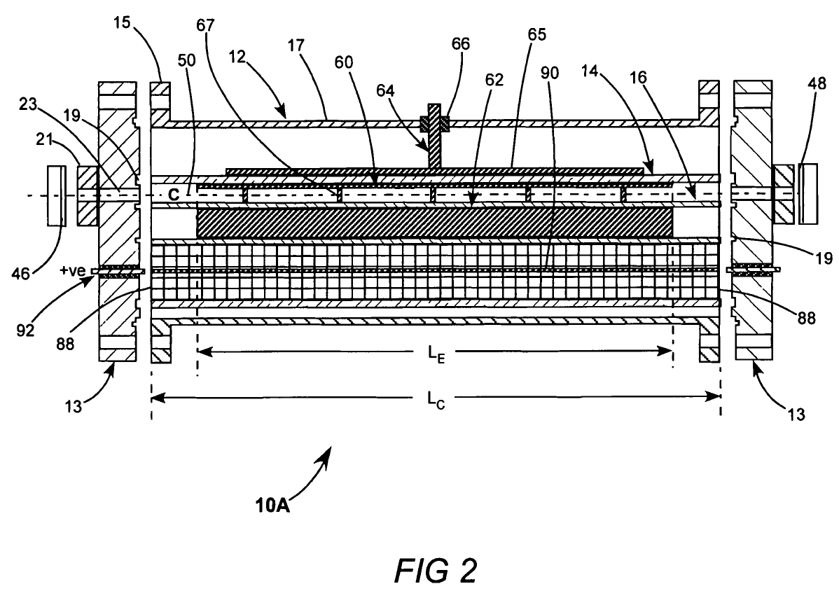

Referring now to the drawings, wherein like components are designated by like reference numerals, FIG. 1 is a lateral cross-section view schematically illustrating a preferred embodiment 10 of a sealed-off excimer laser in accordance with the present invention. FIG. 1A is a simplified rendition of FIG. 1, designating important dimensions. FIG. 2 is a longitudinal cross-section view, schematically illustrating one possible assembly arrangement 10A of an example of laser 10 of FIG. 1. It should be noted that while the overall layout of the laser of FIG. 2 is the same as that of FIG. 1 some corresponding dimensions are different.

Laser 10 includes an enclosure 12, which contains an excimer-forming (exciplex-forming) laser gas mixture of the type discussed above. Enclosure 12 is preferably formed from steel, with the inner surface of the steel enclosure being passivated with fluorine. Other metals such as aluminum A (Al) and copper (Cu) may also be used. Located within enclosure 12 are two cylinders 14 and 16 of an insulating (dielectric) material. Cylinder 14 has a diameter A greater than that of the diameter B of cylinder 16. The cylinders are longitudinally aligned, preferably eccentrically, as depicted in FIGS. 1 and 1A. In this eccentric alignment, there is a gap 18 between the cylinders having a width varying from a minimum width C, to a maximum width D, diametrically opposite the minimum width C. Cylinder 14 is preferably formed from a ceramic material such as alumina (Al₂O₃).

Cylinder 16 is preferably formed from a crystal dielectric material such as sapphire (crystalline Al₂O₃). This is because cylinder 16 preferably has as relatively high dielectric constant, a relatively high thermal conductivity, and a relatively high breakdown-field, with the latter being the most important. By way of example, alumina has a dielectric constant (Er) between about 9.0 and 10.0, a thermal conductivity of about 28.0 Watts per meter per degree Kelvin (W/m*K), and a breakdown field of about 25.0 kilovolts per millimeter (kV/m). Sapphire has a dielectric constant (Er) between about 7.5 and 11.0, a thermal conductivity of between about 35.0 W/m*K and 40.0 W/m*K, and a breakdown field of about 50.0 kV/m. Other dielectric materials such as barium titanate (BaTiO₃) may be used for cylinder 16 without departing from the spirit and scope of the present invention.

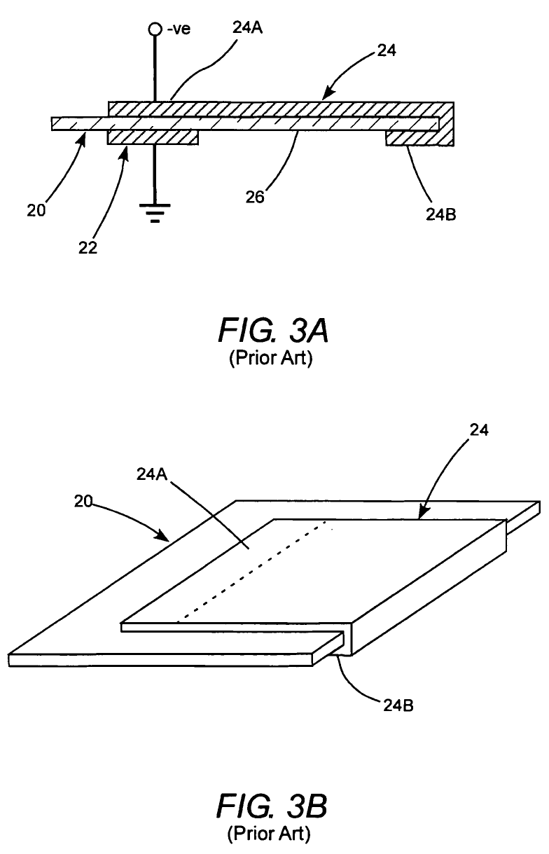

In laser 10, lasing gas is excited by creating a gas-discharge or plasma in the gas, making use, in part, of a phenomenon known in the art as a “creeping” or “sliding” discharge. Before discussing the specific electrode arrangements in laser 10 for exciting the lasing gas, it is useful to review, with reference to FIG. 3A and FIG. 3B, how a sliding discharge is created in accordance with principles of the prior-art. Here, a dielectric barrier 20 has disposed thereon an elongated anode-electrode (anode) 22 and an elongated cathode-electrode (cathode) 24. A portion 24A of cathode 24 is aligned with anode 22 on an opposite side of dielectric barrier 20. Cathode 24 is wrapped around the dielectric barrier such that a portion 24B of the cathode is on the same side of the dielectric barrier as anode 22, leaving a portion 26 of the surface of the dielectric barrier between anode 22 and cathode portion 24B.

An electric potential in the form of a negative high-voltage pulse from a discharging electrical capacitor (not shown) is applied to cathode 24 with anode 22 at ground potential. Increasing potential in the pulse leads to a high electric field between cathode portion 24A and anode 22 and creates a corona-discharge around and along anode 22. Anode 22 is often referred to by practitioners of the art as the “stressed electrode”. The thickness of the dielectric barrier is selected such that the corona-discharge can not penetrate the dielectric barrier and strike through to cathode portion 24A. As the pulse potential further increases, a component of the electric field in the direction from anode 22 to cathode portion 24B correspondingly increases, such that the discharge creeps or slides along surface 26 towards cathode portion 24B. Once the potential reaches a certain critical value, a few individual discharge filaments build up in the direction toward cathode portion 24B, and transform into arc-discharges, whereby the energy stored in the capacitor discharges over these few filaments. If the potential increases significantly above this critical value, for example, by a factor of about two, and the potential rise-time is sufficiently short, very many filaments form, packed tightly together, and covering the entire surface 26 between anode 22 and cathode portion 24B. The number of filaments increases with increasing potential, and the distribution of the filaments becomes more homogeneous, in which case, the energy discharged from the capacitor is homogeneously distributed over all filaments, and no arcs are created. This provides a homogeneous, stable discharge (plasma) 27 extending the entire length of surface 26 between anode 22 and cathode portion 24B.

In theory, it ought to be possible to create such a sliding discharge in an excimer forming laser-gas and arrange a laser-resonator with a longitudinal axis extending through the discharge to generate radiation. In experiments performed preparatory to designing the inventive laser, however, it was not possible to generate laser radiation through such a prior-art sliding discharge, presumably because the discharge-sheet has a thickness of only about 0.2 mm or less. It was decided to experiment with a modified electrode and dielectric barrier arrangement that would a create a gas-discharge including a sliding discharge (surface-discharge) portion and a volume-discharge portion, around which volume-discharge portion a laser resonator could be arranged to generate laser radiation (pulses).

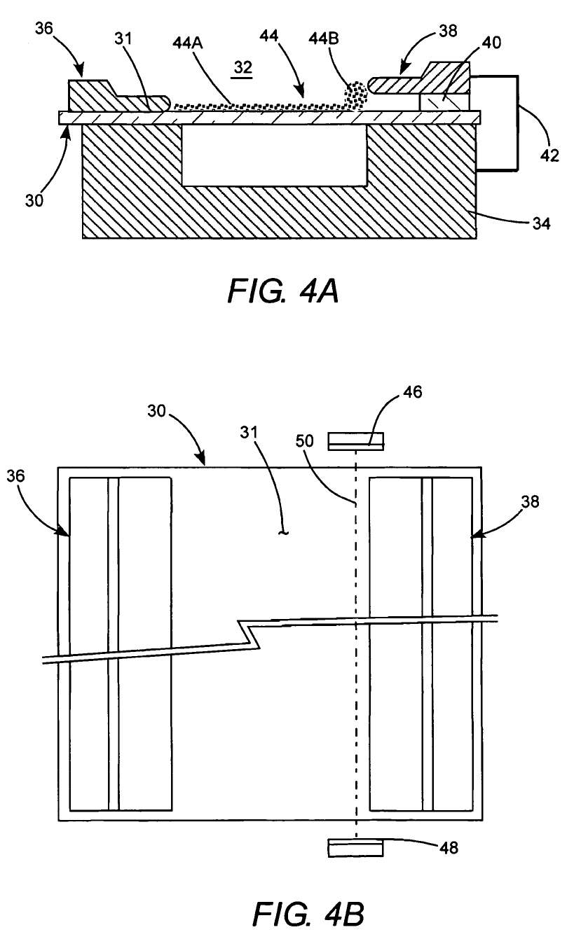

One such experimental arrangement is schematically illustrated in FIG. 4A and FIG. 4B. Here a sapphire (dielectric) sheet 30 having a thickness of about 1.0 mm is located in an enclosure 32 including a lasing gas mixture. Walls of the enclosure are not shown in FIGS. 4A and 4B for convenience of illustration. Dielectric sheet 30 is supported on a metal base 34. A first elongated (strip) electrode 36 is held in contact with upper surface 31 of dielectric sheet 30. A second elongated (strip) electrode 38 is supported about 1.0 mm above the upper surface of the dielectric sheet by a ceramic spacer 40. Electrode 38 is electrically connected to base 34 by an electrical connection 42. It was possible, in the experimental arrangement, to vary the polarity of electrode 36, which is the equivalent of the stressed electrode in the prior-art arrangement of FIGS. 3A and 3B.

When a high potential (pulse) is established between electrodes 36 and 38, a gas-discharge 44 electrically connects the electrodes. Gas-discharge 44 includes a sliding discharge (surface-discharge) portion 44A, extending across the upper surface of dielectric sheet 30 between the electrodes, and a volume-discharge portion 44B electrically connecting the surface-discharge portion to electrode 38. Surface-discharge portion 44A has the same stability and homogeneity characteristics as the above-discussed, prior-art sliding discharge, and these advantageous characteristics are inherited by volume-discharge portion 44B. A laser resonator, schematically illustrated in FIG. 4B as being formed between mirrors 46 and 48, can be arranged with longitudinal axis 50 thereof extending through the location between the electrodes where volume-discharge portion 44B of gas-discharge 44 occurs. Such a resonator was used to experimentally determine suitable operating ranges and characteristics for laser 10.

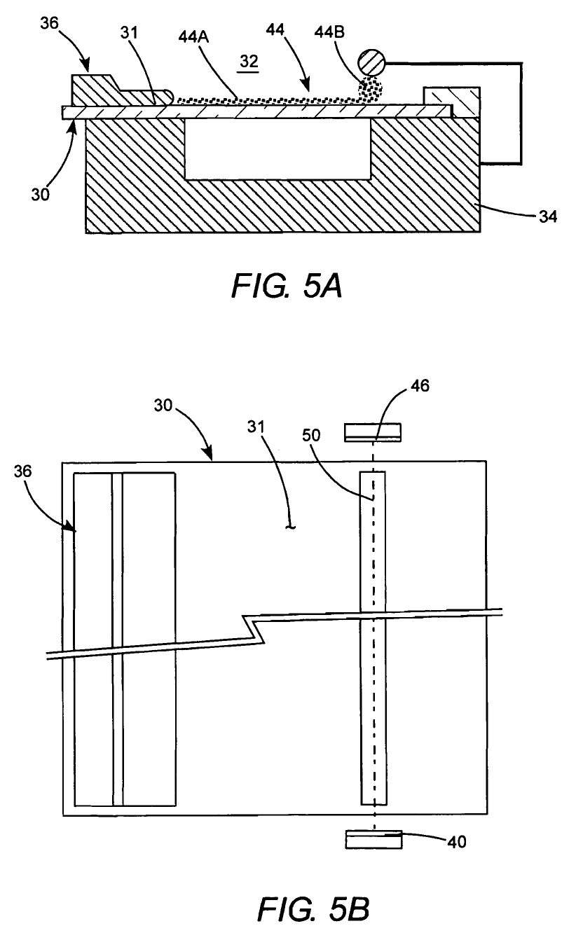

FIG. 5A and FIG. 5B schematically illustrate another experimental laser arrangement that was used for determining such operating ranges and characteristics. The laser of FIGS. 5A and 5B is similar to the laser of FIGS. 4A and 4B with an exception that strip-electrode 38 is replaced by a rod-electrode 39. The rod-electrode is a brass rod having a diameter of about 3.0 mm and is positioned about 2.5 mm above the surface of plate 30. This replacement of the strip-electrode with the rod-electrode created space for experimenting with effects of gas circulation through the volume-discharge by means of the well known ion-wind effect, which is discussed in further detail below. Results of experiments conducted with the above-described experimental lasers are summarized further hereinbelow in the context of suggested operating parameters for laser 10.

Referring again to FIG. 1, FIG. 1A, and FIG. 2, the inventive electrode arrangement in laser 10 includes cathode electrodes (cathodes) 60 and 62. Cathode 62 is in contact with the inner surface of cylinder 16. Cathode 60 is in contact with the inner surface of cylinder 14. The cathodes are electrically connected together by a conductive rod 64 extending through an insulating feed-through 66 in enclosure 12. Here, it should be noted that the connection of the cathodes is simplified in FIG. 1A for convenience of description. An alternative connection arrangement is depicted in FIG. 2, and is described further hereinbelow. Rod 64 is electrically connected by a switch 68 (such as a thyratron switch or a solid-state switch) to one side of a capacitor 70. An anode electrode 72 is connected via an electrically conductive rod 74 to the other side of capacitor 70, and to ground potential. Electrodes are preferably held in contact with cylinder surfaces by springs (not shown). Contact rods, such as rod 64, penetrate the dielectric cylinders via holes bored therein (not specifically designated).

Capacitor charging and switching arrangements in FIG. 1A are greatly simplified for convenience of description. Capacitor charging and high voltage pulse switching circuitry is well-known to those skilled in the excimer laser art, and a description thereof is not required for understanding principles of the present invention. Accordingly such a detailed description is not presented herein.

Continuing with reference in particular to FIG. 1 and FIG. 1A, cathode 62 is in contact with the inner surface of cylinder 16, over an angular width a thereof. One longitudinal edge 62A of the contact surface of the cathode is longitudinally aligned about along narrowest portion C of gap 18 between cylinders 14 and 16. The other longitudinal edge 62B of the contact surface of the cathode is longitudinally aligned along cylinder 16 near the widest portion D of gap 18.

Referring to FIG. 2, the length of anode 72 and cathodes 60 and 62 (the electrodes) is about equal (L_{E}), and is most preferably somewhat less, for example about 20 mm less, than the length L_{C} of cylinders 14 and 16. The electrodes are disposed with respect to the cylinders such that the cylinders overhang the electrodes at each end thereof. This is important for preventing arcs, particularly between cathode 62 and anode 72.

Referring again to FIGS. 1 and 1A, in the above-described inventive electrode arrangement, when an electrical pulse of sufficient magnitude and sufficiently short duration is applied across anode 72 and cathodes 60 and 62, a gas discharge 44, having a surface-discharge portion 44A and a volume discharge portion 44B is created, as described above with reference to the experimental arrangements of FIGS. 4A and 5A, and electrically connects anode 72 to cathode 60. Surface-discharge portion 44A of the discharge forms over the surface portion of cylinder 16 bounded by longitudinal edge 72A of anode 72 and longitudinal edge 72A of cathode 72. Volume-discharge portion 44B of discharge 44 electrically connects the surface discharge-portion to longitudinal edge 60A of cathode 60 at the point where the surface-discharge aligns with longitudinal edge 62A of cathode 62. Volume-discharge portion 44A extends longitudinally through gap 18 in narrowest portion C thereof. A laser-resonator (see FIG. 2) can be formed between mirrors 46 and 48 with the longitudinal axis 50 of the laser resonator extending through the volume-discharge region (not shown in FIG. 2) in narrowest portion C of the gap. It should be noted here that it is not absolutely essential that cathode 60 is in contact with the entire inner surface of cylinder 16 between edges 60A and 60B of the cathode, it is strongly recommended that this is the case. This serves to maximize homogeneity of surface-discharge portion 44A of discharge 44 and maximize energy on volume-discharge portion 44B of discharge 44.

In laser 10, gas circulation is achieved via an effect, known in the art as an ion-wind, by which a gas-discharge in an inhomogeneous electric field can cause an ion drift (ion-wind) of about 1.0 meter per second (m/s) or greater. A preferred arrangement (ion-wind generator) 89 for providing this ion-wind includes a mesh electrode 88 extending completely across gap 18 between the outer surface of cylinder 16 and the inner surface of cylinder 14. One suitable mesh dimension is about 5.0 mm×5.0 mm with a wire mesh diameter of about 0.5 mm. Electrode 88 here is in electrical contact with anode 72 and accordingly at ground potential. A wire or rod electrode 90 is located in gap 18 about mid way between the inner surface of cylinder 14 and the outer surface cylinder 12 and spaced apart, preferably by between about 5.0 mm and 20.0 mm, from electrode 88. Electrode 90 extends the entire length of cylinders 14 and 16 and is connected to either a high CW positive potential or a high CW negative potential, for example, between about +1.0 kilovolts (kV) and ±15 kV, via an insulating feed-through 92 in enclosure 12 (see FIG. 2). The applied high potential creates a corona discharge around electrode 90. The ion-wind direction is indicated in FIG. 1 by arrows W. Selection of the polarity of the applied potential is determined by polarity of ions generated in the corona, which is in turn determined by the excimer-forming components of the lasing gas.

FIG. 2 schematically illustrates a preferred assembly arrangement 10A of laser 10. Here, enclosure 12 includes aluminum end plates 13 which would be attached to flanges 15 on a metal tube 17, for example a steel tube or an aluminum tube. Cylinders 14 and 16 are supported in plates 13 via slots 19 in the plates. Windows 21 and apertures 23 in plates 13 provide an optical access to enclosure for axis 50 of the resonator and laser-radiation circulating in the resonator. Preferably, plates 13 are sealed to flanges 15, and windows 21 are sealed to plates 13, via metal gaskets. In laser 10A, electrodes 60 and 62 are not connected directly by rod 64 as depicted in laser 10 of FIG. 1. In laser 10A, rod 64 contacts a busbar 65, and a plurality of contact rods 67 connect electrodes 60 and 62 to each other and to busbar 65.

Regarding preferable dimensions of laser 10, in one preferred example thereof, cylinder 14 has diameter A of between about 30 mm and 150 mm and a wall thickness of between about 1 mm and 5 mm. Cylinder 16 has diameter B of between about 15 mm and 75 mm and a wall thickness of between about 1 mm and 5 mm. Cylinders 14 and 16 are eccentrically arranged such that, in location C of gap 18, the exposed surface of cathode 60 is between about 1 mm and 10 mm above the outer surface of cylinder 16. Cylinders 14 and 16 have a length L_{C} between about 100 mm and 300 mm. Length L_{C} is scaleable. Electrodes 60, 62, and 72 have length L_{E} between about 20 mm and 30 mm less than L_{C}. In terms of circumferential width, surface-discharge portion 44A of discharge 44 preferably has a width between about 10 mm and 30 mm, for example about 15 mm. This corresponds to a circumferential separation of edge 72A of anode 72 and edge 62A of cathode 62 of about the same dimensions.

Electrodes 88 and 90 are spaced apart by between about 10 mm and 30 mm, for example about 15 mm. Electrode 90 is preferably at a potential between about ±1 kV and ±15 kV, for example about 110 kV, with the polarity depending on the lasing-gas composition as discussed above. It is estimated that, at usual excimer lasing-gas pressure, with an electrode spacing of about 2 mm, and an applied potential of about 15 kV, an ion-wind velocity in location C of gap 18 of about between about 1.0 m/s and 5.0 m/s could be created. This is assisted by the gap-narrowing resulting from the eccentric arrangement of the cylinders. It is believed that the efficiency of generation of the ion-wind will be significantly greater for a positive potential applied to electrode 90 than for a negative potential applied to electrode 90.

Regarding lasing gas mixtures, it is believed that most excimer lasing-gas mixtures use in prior-art excimer lasers would be suitable as lasing-gas mixtures in a laser in accordance with the present invention. Accordingly, lasing-gas mixtures for forming excimers He₂*, Ne₂*, Ar₂*, Kr₂*, Xe₂*, F₂*, Cl₂*, Br₂*, or I₂*, or exciplexes NeF*, ArF*, KrF*, XeF*, ArCl*, KrCl*, XeCl*, KrBr*, XeBr*, KrI*, or XeI* may be used. In experiments performed with the arrangements of FIGS. 4A and 5A, KrF*-forming lasing gas mixtures of (120)F/(80)Kr/(1800)Ne and (120)F/(110)Kr/(3700)Ne were employed, among others, where, here, the numbers in parentheses represent the gas proportions in the mixture. Laser 10 is expected to be able to deliver pulsed output with pulses having a duration comparable with prior-art excimer lasers, for example between about 1.0 ns and 20.0 ns.

Regarding total gas pressure in enclosure 12 preferably this is between about 500 millibars (mb) and 5000 mb. It was found that, at a PRF of 100 Hz, pulse energy increased with total pressure, reaching an asymptotic maximum energy at a pressure of about 4500 mb.

It was found that, for PRF greater than about 10.0 Hz, pulse energy decreased with increasing PRF, with useful pulse energy being obtainable at PRFs of up to about 1000 Hz. It was also found that pulse energy, and the reduction of pulse energy with PRF, is strongly dependent on the polarity of the stressed electrode, ie., electrode 36 in the experimental arrangements of FIGS. 4A and 5A, which corresponds to anode 72 of laser 10. It was found that, at a PRF of 100 Hz, pulse energy with a negative stressed-electrode was about 60% of the pulse energy with a positive stressed-electrode, while at a PRF of 300 Hz, pulse energy with a negative stressed-electrode was only about 25% of the pulse energy with a positive stressed-electrode. Accordingly, in the preferred operation of laser 10, electrode 72 is an anode, and electrodes 60 and 62 are cathodes as described. This, however, should not be considered as limiting the invention, as clearly laser 10 could function with electrode 72 as a cathode, and electrodes 60 and 62 as anodes, albeit with some possible compromise in performance, as indicated by the experimental results.

Regarding potential difference between the anode and cathode in laser 10, i.e., the peak voltage of applied pump pulses, this is preferably between about 12 kV and 22 kV for pulses having a rise-time of about 50 ns or less. Pulse energy can be expected to increase with increasing peak voltage through this range, provided that ion-wind gas-circulation is provided. In the above-discussed experimental arrangements, peak efficiency (electric to optical) was found to occur at peak voltages between about 15 kV and 19 kV for a PRF of 100 Hz.

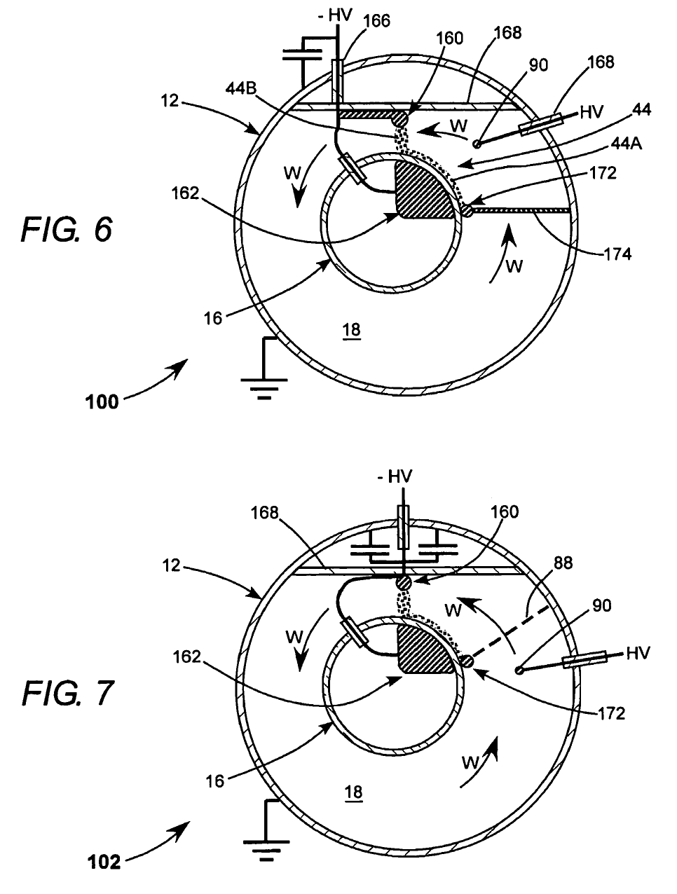

FIG. 6 is a lateral cross-section view schematically illustrating another preferred embodiment 100 of a sealed-off excimer laser in accordance with the present invention. Laser 100 is similar to laser 10 of FIG. 1 but differs therefrom inasmuch as dielectric cylinder 14 of laser 10 is omitted, the shape of the cathodes and are simpler, and the ion-wind generating arrangement does not include a grid electrode 88. Because of the similarity of laser 100 with laser 10 only principal differences are described herein. Other functions will be evident from the detailed description of laser 10 presented above.

In laser 100, a cathode 160 comparable in function to cathode 60 of laser 10 is attached to a dielectric plate 168 spanning the upper portion of cylindrical enclosure 12. Cathode 160 receives high voltage pulses (−HV) via an insulating feedthrough 166 in enclosure 12. A cathode 162 within dielectric cylinder 16 is comparable in function to cathode 62 of laser 10 but is simpler in configuration. Cathodes 160 and 162 are electrically connected. An anode-electrode or stressed electrode 172 in the form of a rod is held in contact with cylinder 16 by an electrical connection 174, thereby connecting the anode to the enclosure, which is grounded. The high voltage pulses applied to the cathodes cause a discharge 44 having a surface-discharge portion 44A and a volume-discharge portion 44B as described above with reference to laser 10 of FIG. 1. An ion-wind is created by locating a wire electrode 90, supplied with constant high potential (HV), relatively close to discharge 40. This causes the ion-wind to circulate around the interior 18 of enclosure 12 as indicated by arrows W.

FIG. 7 is a lateral cross-section view schematically illustrating yet another preferred embodiment 102 of a sealed-off excimer laser in accordance with the present invention. Laser 102 is similar to laser 100 of FIG. 6 with exceptions as follows. Cathode 160 of laser 102 has a simple rod shape. Ion-wind is generated by wire electrode 90 in cooperation with a grid electrode 88, as in laser 10 of FIG. 1. Anode 72 is connected to grounded enclosure 12 by grid electrode 88.

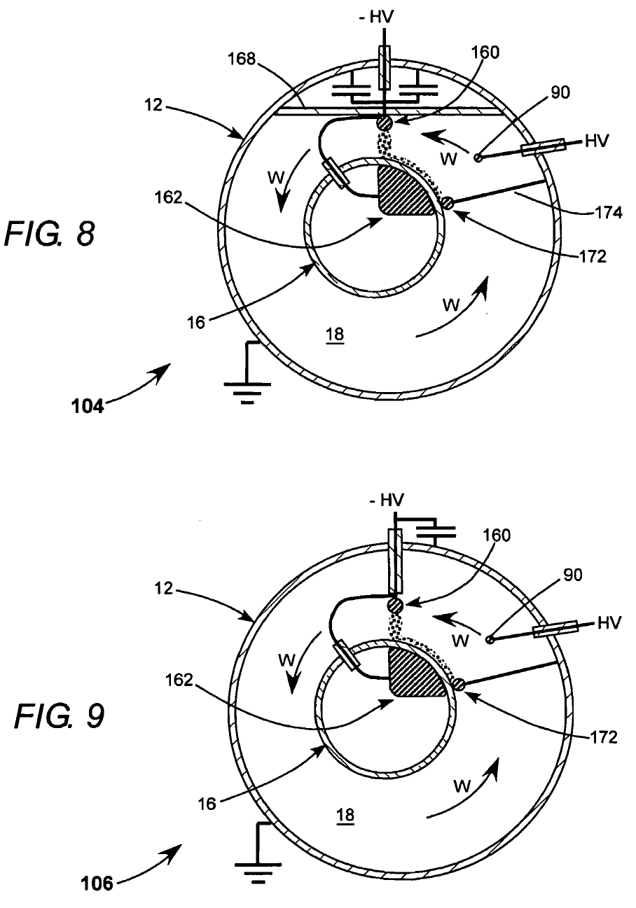

FIG. 8 is a lateral cross-section view schematically illustrating still another preferred embodiment 104 of a sealed-off excimer laser in-accordance with the present invention. Laser 104 is similar to the laser 102 of FIG. 7 but has the ion-wind generating arrangement and anode-to-enclosure connection arrangement of laser 100 of FIG. 6.

FIG. 9 is a lateral cross-section view schematically illustrating a further preferred embodiment 106 of a sealed-off excimer laser in accordance with the present invention. Laser 106 is similar to laser 104 of FIG. 8 but with an exception that dielectric plate 168 is omitted and cathode 160 is simply suspended from high voltage feedthrough 166.

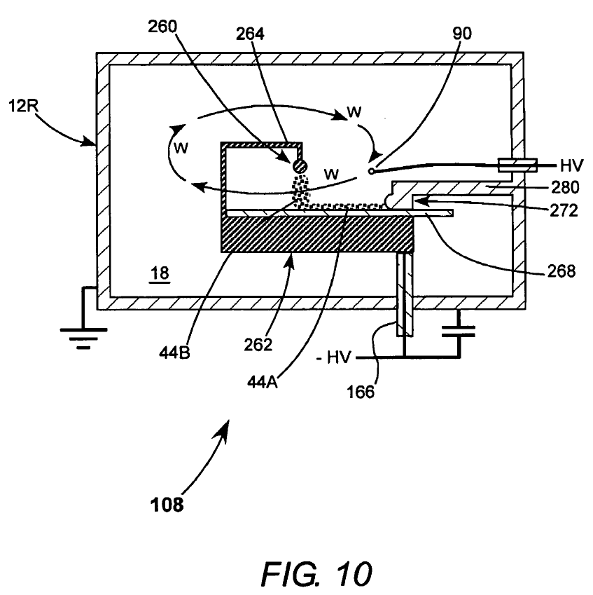

FIG. 10 is a lateral cross-section view schematically illustrating still yet another preferred embodiment 108 of a sealed-off excimer laser in accordance with the present invention. Laser 108 differs 10, 100, 102, 104, and 106 inasmuch a lasing gas an electrodes are contained in a rectangular metal enclosure 12R rather than cylindrical enclosure 12. Laser 108 includes cathodes 260 and 262 comparable in function to cathodes 60 and 62 and to cathodes 160 and 162 discussed above. Cathode 262 has a rectangular cross-section and supports a dielectric plate 268. Cathode 260 is suspended above the dielectric plate and electrically connected to cathode 262 by an arm 264. An anode 272 is in contact with dielectric plate 268 and electrically connected by an arm 280 to enclosure 12R. Cathodes 260 and 262 are supplied with high voltage pulses via a feedthrough 166 in enclosure 12R. The high voltage pulses give rise to a discharge 44 (general numeral not shown) including a surface-discharge portion 44A over the upper surface of the dielectric plate and a volume discharge portion 44B connecting the surface discharge portion to cathode 260. An ion-wind is created by a wire electrode 90 in the vicinity of the discharge. The ion-wind circulates through the volume-discharge portion 44B as indicated by arrows W. While cathodes 260 and 262 have been referenced as two cathodes, it should be apparent that they may be formed as a single unit since they are at the same electrical potential. The identification in the claims as second and third electrodes should not be construed to mean that there must be two physically separate electrodes.

Those skilled in the art from the description of cylindrical embodiments of the inventive excimer laser may conceive other rectangular-enclosure embodiments of the laser comparable to the embodiment of FIG. 10 without departing from the spirit and scope of the present invention. Such embodiments may include, among other features, different electrode shapes and methods of connection, and ion-wind generating arrangements including an accelerator grid as described above.

It should be noted, here, that the arrangements, dimensions and parameters discussed above are merely exemplary and should not be construed as limiting the present invention. Those skilled in the art, from the description presented above may devise other arrangements and select other operating parameters without departing from the spirit and scope of the present invention. It should also be noted that while the inventive sealed-off laser is described above in terms of an excimer laser, principles of the invention are also applicable to other gas discharge laser types, for example, carbon dioxide (CO₂) lasers or nitrogen (N) lasers.

In summary, the present invention is described above in terms of a preferred and other embodiments. The invention is not limited, however, to the embodiments described and depicted. Rather, the invention is limited only by the claims appended hereto.

What is claimed is:

1. A laser, comprising:
an enclosure containing a lasing-gas;
a dielectric member located in said enclosure and having a first surface
an electrode arrangement, said electrode arrangement including a first elongated electrode in contact with and extending along said first surface of said dielectric member and a second elongated electrode supported above said first surface of said dielectric member, laterally spaced from said first electrode, and parallel thereto;
said first and second electrodes being configured such that when a potential difference is established therebetween, said electrodes are electrically connected by a gas-discharge in the lasing gas, said gas-discharge having a surface-discharge portion extending from said first electrode over said first surface of said dielectric member and a volume-discharge portion connecting said surface-discharge portion to said second electrode;
a laser resonator, said laser resonator having a longitudinal axis extending through said volume discharge portion of said gas-discharge; and
an ion-wind generator for causing circulation of said lasing-gas through said volume-discharge portion of said gas discharge.

2. The laser of claim 1, further including a third electrode, electrically connected to said second electrode and in contact with a portion of a second surface of said dielectric member opposite to said first surface of said dielectric member, said portion of said second surface of said dielectric member being aligned with the lateral space between said first and second electrodes.

3. The laser of claim 1, wherein, when the potential difference between said first and second electrodes is established, said second and third electrodes are at about the same electrical potential.

4. The laser of claim 1, wherein said dielectric member is a plate.

5. The laser of claim 4, wherein said second electrode is supported above said surface of said plate by a ceramic spacer in contact with the first surface of the plate.

6. The laser of claim 1, wherein said dielectric member is a first dielectric cylinder having an inner surface and an outer surface and said surface with which said first electrode is in contact is the outer surface of said first cylinder.

7. The laser of claim 6, further including a second dielectric cylinder having an inner surface and surrounding said first dielectric cylinder leaving a gap between the inner surface of said second dielectric cylinder, and wherein said second electrode is in contact with the inner surface of said second dielectric cylinder.

8. The laser of claim 7, further including a third electrode, electrically connected to said second electrode and in contact with a portion of the inner surface of said first dielectric cylinder, said portion of inner surface of said first dielectric cylinder being aligned with the lateral space between said first and second electrodes.

9. The laser of claim 1, wherein said first electrode functions as an anode and said second electrode functions as a cathode.

10. The laser of claim 1, wherein, when the potential difference between said first and second electrodes is established, said first electrode is at a positive potential.

11. The laser of claim 1, wherein said lasing gas includes an element selected from a group of elements consisting of helium, neon, argon, krypton, and xenon.

12. The laser of claim 1, wherein said lasing gas includes an element selected from a group of elements consisting of fluorine, chlorine, bromine, and iodine.

13. The laser of claim 1, wherein said lasing gas includes one element selected from a first group of elements consisting of helium, neon, argon, krypton, and xenon, and one element from a second group of elements consisting of fluorine, chlorine, bromine, and iodine.

14. The laser of claim 1, wherein said lasing gas includes krypton and fluorine.

15. The laser of claim 1, wherein said potential difference between said first and second electrodes is established by an electrical pulse.

16. The laser of claim 15, wherein said electrical pulse has a rise-time less than about 50 nanoseconds.

17. The laser of claim 16, wherein said potential difference is between about 12 kilovolts and 22 kilovolts.

18. The laser of claim 17, wherein said potential difference is between about 15 kilovolts and 19 kilovolts.

19. The laser of claim 1, wherein said lasing gas is at a pressure between about 500 millibars and 5000 millibars.

20. The laser of claim 1, wherein said lasing gas is at a pressure of about 4500 millibars.

21. A laser, comprising:
an enclosure containing a lasing-gas;
first and second cylinders located in said enclosure, each thereof formed from an electrically insulating material and each thereof having an inner surface and an outer surface, said first cylinder located within second cylinder leaving a gap between said outer wall of said first cylinder and said inner wall of said second cylinder;
an first elongated electrode in contact with and extending along a longitudinal portion of said outer surface of said first cylinder, and second and third elongated electrodes electrically connected to each other, said second electrode being in contact with and extending along a longitudinal portion of said inner surface of said second cylinder, said third electrode in being in contact with and extending along a longitudinal portion of said inner surface of said first cylinder, said first second and third electrodes being configured and arranged such that when a potential difference is established between said first electrode and said second and third electrodes, a surface gas-discharge in the lasing-gas extends over a longitudinally extending portion of said outer surface of said first cylinder and electrically connects to said second electrode via a volume gas-discharge in said lasing-gas in said gap at a location therein between said second and third electrodes;
a laser-resonator, said laser-resonator having a longitudinal axis extending through said gap at said location therein where said volume discharge occurs; and
an ion-wind generator arranged to cause circulation of said lasing-gas through said volume-discharge portion of said gas discharge.

22. The laser of claim 21, wherein each of said first, second, and third electrodes has first and second opposite edges, said first edge of said first electrode being aligned with said first edge of said third electrode, said second edge of said first electrode aligned between said first and second edges of said third electrode, said first edge of said second electrode being aligned with said second edge of said third electrode, and said second edge of said second electrode being on an opposite side of said volume gas-discharge location to said surface gas-discharge.

23. The laser of claim 22, wherein said surface-discharge extends along said outer surface of said first cylinder between said second edge of said first electrode and a location on said outer surface of said first cylinder corresponding to about the location of said second edge of said third electrode on said inner surface of said first cylinder.

24. The laser of claim 22, wherein said third electrode is in contact with said inner surface of said first cylinder along the entire portion thereof between the location of said second edge of said third electrode thereon and a location thereon corresponding to the location of said second edge of said first electrode on said outer surface of said first cylinder.

25. The laser of claim 24, wherein said third electrode is in contact with said inner surface of said first cylinder along the entire portion thereof between the location of said second edge of said third electrode thereon and a location thereon corresponding to the location of first edge of said first electrode on said outer surface of said first cylinder.

26. The laser of claim 21, wherein, when the potential difference between said first electrode and said second and third electrodes is established, said second and third electrodes are at about the same electrical potential.

27. The laser of claim 21, wherein said first electrode functions as an anode and said second and third electrodes function as a cathode.

28. The laser of claim 21, wherein, when the potential difference between said first electrode and said second and third electrodes is established, said first electrode is at a positive potential.

29. The laser of claim 21, wherein said potential difference between said first electrode and said second and third electrodes is established by an electrical pulse.

30. The laser of claim 29, wherein said electrical pulse has a rise-time less than about 50 nanoseconds.

31. The laser of claim 29, wherein said potential difference is between about 12 kilovolts and 22 kilovolts.

32. The laser of claim 31, wherein said potential difference is between about 15 kilovolts and 19 kilovolts.

33. The laser of claim 21, wherein said first and second cylinders are eccentrically aligned such that said gap therebetween has a narrowest portion and a widest portion diametrically opposite said narrowest portion, and wherein said electrodes are configured and arranged such that volume gas-discharge occurs in said narrowest portion of said gap.

34. The laser of claim 33, wherein said ion-wind generator includes fourth and fifth electrodes located in about the widest portion of said gap and is arranged to cause said circulation of said lasing-gas around said first cylinder and through said narrowest portion of said gap, when a potential difference is established between said electrodes.

35. The laser of claim 34, wherein said fourth electrode is one of a grid electrode and a wire-mesh electrode extending longitudinally along said gap and extending from said first cylinder to said second cylinder and said fifth electrode is one of a rod electrode and a single-wire electrode extending longitudinally along said gap and spaced apart from said fourth electrode.
